(19) United States
(12) Patent Application Publication
(10) Pub. No.: US 2012/0123896 A1
(43) Pub. Date: May 17, 2012

(54) DECORATIVE END CAPS FOR FIXTURES

(75) Inventors: Dragan Prodanovic, Grand Rapids, MI (US); Michael W. Regelbrugge, Rockford, MI (US)

(73) Assignee: AMERIKAM, INC., Grand Rapids, MI (US)

(21) Appl. No.: 13/294,407

(22) Filed: Nov. 11, 2011

Related U.S. Application Data
(60) Provisional application No. 61/413,733, filed on Nov. 15, 2010.

(51) Int. Cl. A47K 10/10; G06Q 30/06; F16M 13/00

(52) U.S. Cl. 705/26.5; 211/123

(57) ABSTRACT

Decorative caps for various fixtures that are easy to install, customizable, and interchangeable. The decorative caps can have custom decorations thereupon and when installed are held in proper alignment by mechanical locking such that the custom decoration does not change alignment.

### CROSS REFERENCE TO RELATED APPLICATIONS

This application claims the benefit of U.S. Provisional Patent Application Ser. No. 61/413,733, filed Nov. 15, 2010, which is incorporated herein by reference in its entirety.

### BACKGROUND OF THE INVENTION

This invention relates generally to the field of household fixtures and more particularly to aesthetic and customizable decorative caps for household fixtures.

In a typical household there are multiple functional fixtures that are mounted on the walls of the home. Such fixtures include bath towel fixtures, toilet paper fixtures, curtain hanging fixtures, blind fixtures, hand towel fixtures, cupboard handles, and the like. These fixtures may provide both a functional purpose, such as holding a towel, as well as an aesthetic purpose. The exposed portions of such fixtures may often have decorative features, such as decorative ribs or polished finishes and may be comprised of aesthetically pleasing materials such as brass or brushed nickel. These fixtures may further be comprised of multiple parts that fit together to form the overall fixture.

### SUMMARY OF THE INVENTION

In one embodiment, a fixture for mounting to a surface includes a mounting base with an inner cavity defined by a sidewall and a top opening defined by a top rim, and adapted to mount to the surface with a mounting bracket, an elongated rod mounted to the mounting base within the inner cavity, and a decorative cap having a rear portion disposed within the inner cavity and a visible portion extending into the top opening of the mounting base, wherein the rear portion has an elongated recess configured to nest with the elongated rod and the rear portion further has a predefined orientation relative to the visible portion so that when the elongated recess nests with the elongated rod, the visible portion will be automatically oriented relative to the mounting base.

In another aspect, a method of acquiring a decorative cap by a customer from a vendor includes the steps of presenting the customer with choices of designs for decorative caps on a customer's electronic device, the customer selecting one of the designs presented on the electronic device or a custom design via the electronic device connected to a network, the electronic device communicating the selection via the network to a vendor's server, the vendor's server collecting payment for generating the customer's selected design, and generating the selected design on decorative cap. The method can further comprise the step of verifying if a custom design has copyright protection. Custom designs with copyright protection are not generated on the decorative cap.

### BRIEF DESCRIPTION OF THE DRAWINGS

In the drawings:

FIG. 1 is a plan view of a bath towel fixture mounted on a wall with mounting assemblies with a decorative cap according to one embodiment of the invention.

FIG. 2 is a side view of a portion of the mounting assembly of the bath towel fixture of FIG. 1.

FIG. 3 is a cross-sectional view of the mounting assembly through line 3-3 of FIG. 1.

FIG. 4 is an exploded partial view of the mounting assembly of the bath towel fixture of FIG. 1.

FIG. 5 is a cross-sectional view of a mounting assembly of a bath towel fixture according to another embodiment of the invention.

FIG. 6 is a plan view of a toilet paper mounting assembly according to yet another embodiment of the invention.

FIG. 7 is a cross-sectional view of another embodiment a mounting assembly with an alternative decorative cap locking mechanism.

FIG. 8 is a cross-sectional view of yet another embodiment of a mounting assembly with an alternative decorative cap mounting mechanism.

FIG. 9 is a schematic diagram of a method for ordering a decorative cap portion.

FIG. 10 is a flow diagram illustrating the method of ordering and obtaining a decorative cap.

FIG. 11A is a cross-sectional view of yet another embodiment of a decorative cap.

FIG. 11B is a cross-sectional view of yet another embodiment of a mounting base with the decorative cap of FIG. 11A.

FIG. 12 is a cross-sectional view of a mounting base with an alternative decorative cap according to yet another embodiment.

### DESCRIPTION OF EMBODIMENTS OF THE INVENTION

Household fixtures are commonly found in the household, primarily in the kitchen and bathroom, to serve purposes such as hanging items such as bath towels, hand towels, dish towels, curtains, blinds, and the like. The embodiments of the invention disclosed herein are decorative caps for various fixtures that are easy to install, readily available, customizable, and easily interchangeable. The decorative caps can have custom decorations thereupon and can have a structure for maintaining the alignment of the decorative cap relative to the rest of the fixture. Further, a method of ordering and acquiring custom decorative caps is disclosed.

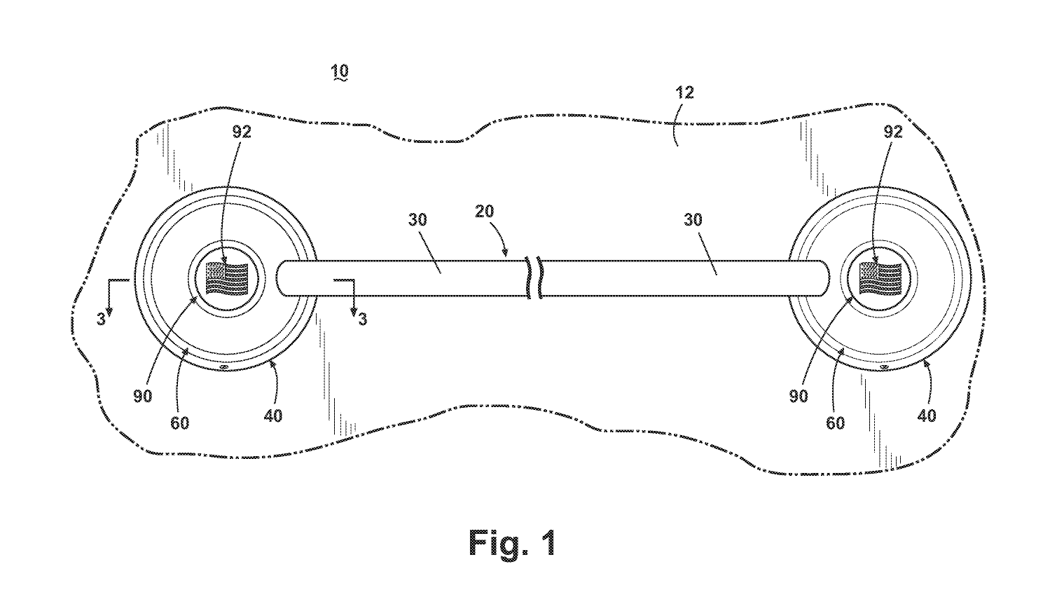

FIG. 1 is a schematic perspective view of a bath towel fixture mounted to a wall 10. The bath towel fixture 20 is mounted to the wall 12 by way of two bath towel mounting assemblies 40, which hold a bath towel rod 30 therebetween. The bath towel mounting assembly 40 further comprises a bath towel mounting base 60 and a bath towel decorative cap 90 disposed near the top of the bath towel mounting base 60. The bath towel decorative cap can have a cap decoration 92 thereupon.

The bath towel decorative cap 90 can be interchangeable and replaceable. Therefore, the cap decoration 92 can be changed by the user with a variety of other decoration. The cap decorations can include any variety of emblems, logos, flags, or characters. Some non-limiting examples of the cap decorations 92 can include cartoon characters, music band emblems, university logos, sports team mascots, holiday decorations, or the like. The ability to choose the interchangeable decorative caps 90 gives the user the ability to customize fixtures incorporating the decorative caps 90. It additionally allows the user to improve the aesthetic appearance of the fixture while allowing the user to change the look of the fixture 20 without replacing the whole fixture 20. For example, a user can have a fixture 20 with a decorative cap 90 with a cap decoration 92 of the user's favorite sports team and during a holiday season, the user may purchase and replace the sports team cap decoration 92 with a decorative cap 90 with a holiday related cap decoration 92. As such, the user is able to customize the look of fixtures throughout the user's home, without purchasing new fixtures. A user may also choose to purchase a decorative cap 90 to match the look and feel of a particular room. Furthermore, a vendor may choose to sell a fixture 20 with a choice of a variety of decorative caps 90. For example, a user may want a fixture with a decorative cap 90 with a color and texture to match the tiles in the user's bathroom. A vendor may choose to offer for sale a mounting base 60 and rod 30 separately from the decorative cap 90, so that the user can select the decorative cap 90 color, texture, and design. As a result, the vendor provides a highly customizable product, without holding a large inventory and variety of the bulkiest parts of the fixture.

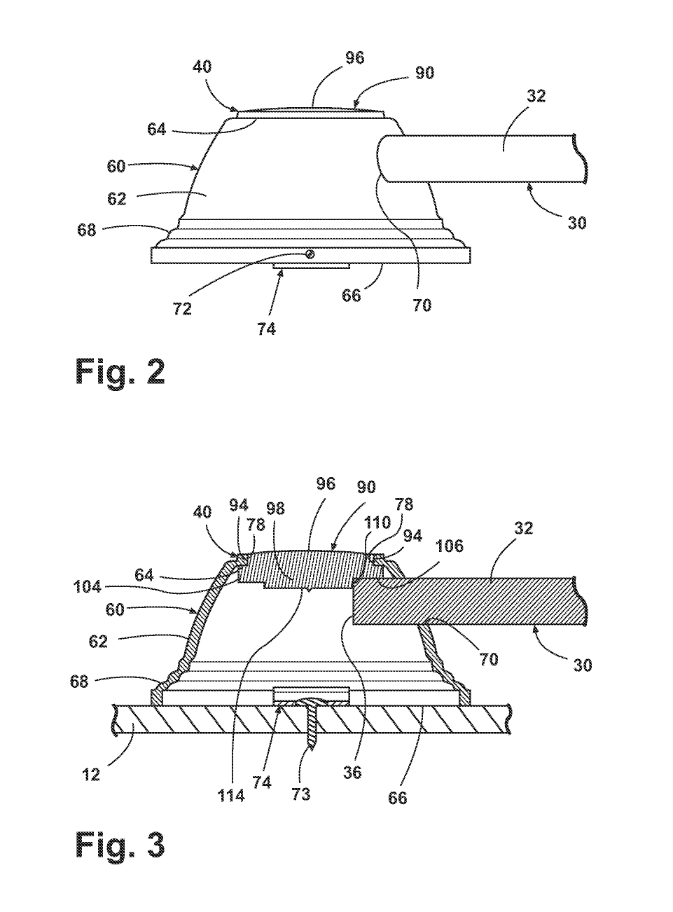

FIG. 2 is a side view of the mounting assembly 40 of the bath towel fixture 20 of FIG. 1 showing the decorative cap 90 disposed upon the mounting base 60 and towel rod 30 attached thereto. The decorative cap 90 comprises a cap surface 96 whereupon the cap decoration 92 is disposed. The mounting base 60 comprises sidewall 62, top rim 64, bottom rim 66, decorative ribs 68 near the bottom of the mounting base 60, a rod mounting opening rim 70, and mounting anchor engagement screw 72. The towel rod 30 comprises a portion external to the mounting assembly 32 and engages the rod mounting opening defined by the mounting opening rim 70 of the mounting base 60. The mounting base 60 is attached to the wall via a wall mounting anchor 74 removably engaged by the anchor engagement screw 72 passing through the mounting base 60.

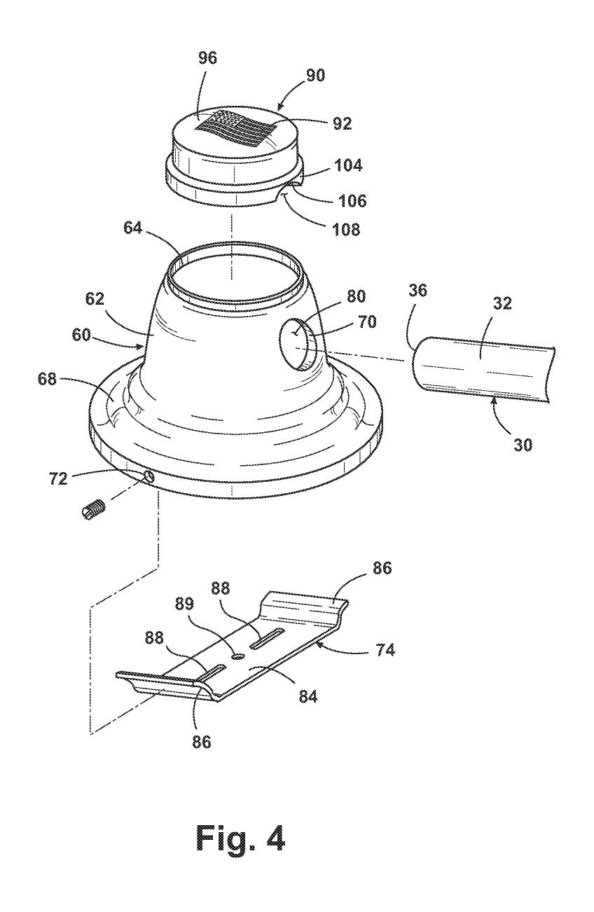

Now referring to FIGS. 3 and 4, the mounting assembly 40 showing the alignment and locking of the decorative cap 90 within the mounting base with the rod 30 is described. FIG. 3 is a cross-sectional view of the mounting assembly 40 through line 3-3 of FIG. 1 and FIG. 4 is an exploded view of the mounting assembly 40 of the bath towel fixture 20 of FIG. 1. The wall mounting anchor 74 comprises a wall mounting anchor base 84 with a wall mounting anchor standard screw hole 89 and two wall mounting anchor elongated screw holes 88 therethrough and wall mounting anchor clips 86 on either end of the wall mounting anchor 74. The wall mounting anchor is mounted to the wall 12 via a wall mounting screw 73 through one of either the standard screw hole 89 or the elongated screw holes 88. The mounting base 60 removably attached to the wall mounting anchor 74 with a wall mounting anchor holding element (not shown) engaging one of the wall mounting anchor clips 86 and the mounting anchor engagement screw 72 engaging the other wall mounting anchor clip 86. As a result, the mounting base 60 can easily engage or disengage with the mounting anchor clip 86, simply by tightening or loosening the mounting anchor engagement screw 72 through engagement screw hole 71.

The mounting base 60 has a top inset 78 that locks the decorative cap 90 in place on the top rim 64 of the mounting base by engaging a cap body 98 with cap body sidewall 104 of the decorative cap 90. The cap body 98 has a greater diameter than the cap surface 96 with cap surface sidewall 94 and as a result the cap surface 96 and portion of the cap surface sidewall 94 protrudes from within the top rim 64, while the cap body 98 has a diameter too great to protrude from within the top rim 64 of the mounting base 60. In other words, the difference in the diameters between the cap surface 96 and the cap body 98 allows the cap body 98 to engage the top inset 78 of the mounting base 60 and allows the cap surface to protrude through the mounting base top rim 64.

The cap portion 90 further comprises a cap base protrusion 114 and cap rod locking inset 108 defined by an end of rod locking inset 110 and cap body portion above rod locking inset 106. A rod end 36 of the rod 30 when inserted through the rod mounting opening 80 sits within the cap rod locking inset 108 and thereby locks the decorative cap 90 in place and disallows rotation of the decorative cap 90. In such a locked position, the rod end 36 butts up against the end of rod locking inset 110. The cap base protrusion 114 prevents the misalignment of the rod 30 when the rod is inserted within the rod mounting opening 80.

The wall mounting anchor element 74 may be fabricated by any known method, including, but not limited to stamping out of sheet metal or molding. The wall mounting anchor 74 may be fabricated out of metals such as iron, stainless steel, aluminum, zinc, bronze, copper or alloys, intermetallics, and combinations thereof. Additionally, the wall mounting anchor 74 may be coated with another material such as zinc, chromium, copper, or cobalt, by any known methods such as electroless plating, electroplating, or painting with metallic paint. Alternatively, the wall mounting anchor 74 may be fabricated from plastic or ceramic materials.

Although a specific wall mounting anchor 74 has been shown, any known wall mounting anchors may be used for mounting the mounting assembly 40 to the wall 12. For example, the wall mounting anchor may be a round shape to provide multiple anchor clips that can be engaged by multiple wall mounting anchor holding elements on the mounting base 60 and mounting anchor engagement screws 72. Although the exact implementation of the wall mounting anchor is not important to the inventive concept, it is advantageous to have a mounting mechanism that makes it relatively easy to disengage the mounting assembly from the wall mounting anchor and thereby remove the fixture 20 from the wall. A relatively quick and simply possibility of dismounting the fixture 20 from the wall 12 provides the ability to easily change the decorative caps 90 within the mounting base 60.

Although the rod 30 is shown to span a part of the diameter of the mounting base 60, the rod 30 may span any portion of the diameter of the mounting base 60. For example, the rod may span the full diameter of the mounting base 60 and contact the side wall 62 of the mounting base 60 at two points along the length of the rod 30, with one point being near the end of the rod 30. The rod locking inset 108 of the decorative cap 90 must be an appropriate length that is dependent upon the extension of the rod 30 into the mounting assembly 60.

Both the mounting base 60 and decorative cap 90 can be fabricated with metallic materials such as aluminum, stainless steel, nickel, bronze, zinc, or the like. Additionally, both parts 60 and 90 can be coated to improve the aesthetic appeal or reduce the corrosion and oxidation of the parts. For example, the parts may be coated with zinc or chromium to prevent the corrosion of the surface of the parts 60 and 90. Methods for fabricating the mounting base 60 and decorative cap 90 can be machining, die casting, or molding. For example the parts 60 and 90 can be fabricated by metal spinning using a lathe.

The mounting assembly may be any height. For example the height of the mounting base may range between 1.5 and 5 inches. The mounting assembly 40 and particularly the mounting base 60 may be taller or shorter based on the application. As an example, for a bath towel mounting assembly 40, it may be advantageous for the mounting base 60 to be relatively taller compared to a mounting assembly of a hand towel to provide enough distance between the rod and the wall for ease in hanging a bath towel on the rod 30.

The rod locking inset 108 of the decorative cap 90 may be formed by any known method. For example the rod locking inset may be formed by grinding into the body 98 of the decorative cap 90 with a grinding head of approximately the same diameter as the rod 30 to ensure a proper radius of curvature of the rod locking inset 108 for a precise and snug fitting of the rod 30 therein. The decorative cap can be machined in a machine shop with a variety of tools such as automated machine tools and computer numerical controlled (CNC) machines.

The rod 30 can be available in standard lengths that are compatible with building standards in the localities where the fixture 20 is sold. For example, the length of the rod 30 can be a length such that the distance between the two mounting assemblies 40 when the fixture 20 is installed is the distance between wall studs. Wall studs are understood to mean the evenly spaced wood scaffolding behind a wall such as a wall constructed of dry wall or sheet rock. Typically, the wall mounting anchor 74, and therefore the fixture 20, can be better secured to the wall if the wall mounting screw 73 passes through a wall stud, rather than dry wall. The distance between wall studs in the United States of America are typically 16 inches or 24 inches. Therefore, if the rod extends approximately 0.5 inches into the mounting base 60 on either side of the bath towel fixture 20, then a typical rod 30 size can be 17 inches or 25 inches. In other countries the rod 30 may be available in different standard sizes, conforming to the building standards in those locations. As an alternative, if the wall mounting anchor 74 cannot be secured to a wall stud, then the wall mounting anchor 74 may be secured to dry wall by known fasteners such as wall anchors or with special drywall screws.

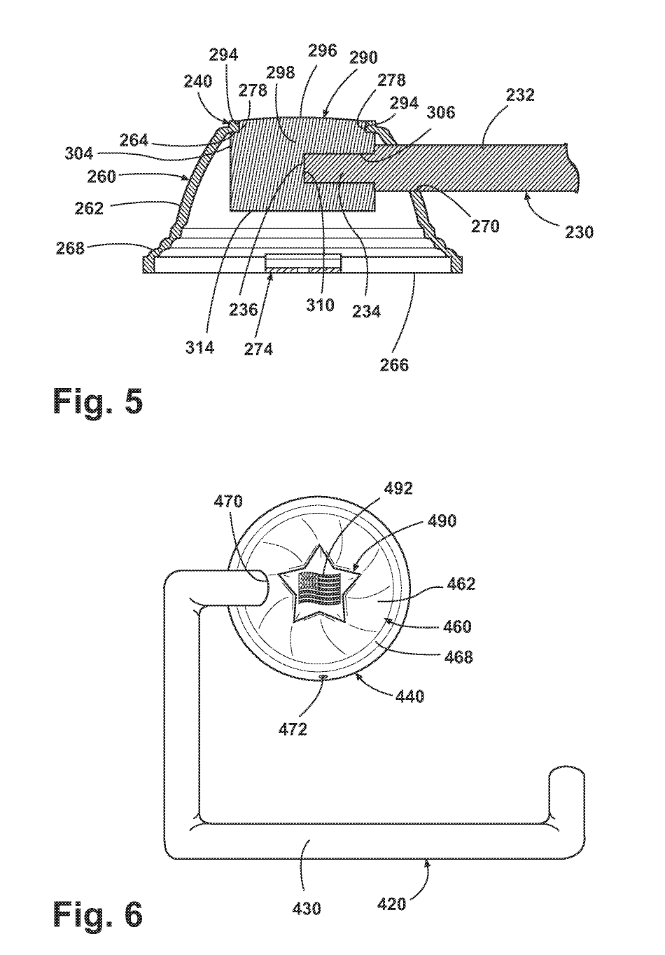

Now referring to FIG. 5, an alternative embodiment of the mounting assembly 240 is shown with an alternate decorative cap orientation locking mechanism. As in the case of the mounting assembly of FIG. 3, the mounting base 260 has a top inset 278 that locks the decorative cap 290 in place on the top rim 264 of the mounting base by engaging a cap body 298 with cap body sidewall 304 of the decorative cap 290. The cap body 298 has a greater diameter than the cap surface 296 with cap surface sidewall 294 and as a result the cap surface 296 and portion of the cap surface sidewall 294 protrudes from within the top rim 264, while the cap body 298 has a diameter too great to protrude from within the top rim 264 of the mounting base 260. In other words, the difference in the diameters between the cap surface 296 and the cap body 298 allows the cap body 298 to engage the top inset 278 of the mounting base 260 and allows the cap surface to protrude through the mounting base top rim 264.

Unlike the mounting assembly 40 of FIG. 1 where the rod 30 has a uniform diameter along its length and there is an cap rod locking inset 106, in this embodiment, the rod 230 has an rod end portion 234 that extends into a cap body locking cavity defined by cavity sidewall 306 in the cap body 298 of the decorative cap 290. The rod end portion 234 has a diameter less than the diameter of the rod portion external to the mounting assembly 232. The mounting base rod opening defined by rim 270 has a diameter to accommodate the diameter of the rod external to the mounting base 232. Alternatively, the portion of the rod inserted through the base rod opening defined by rim 270 may be the diameter of the rod end portion. The diameter of the rod at the base rod opening is not a material distinction of the invention. When the rod end 234 of the rod 230 is inserted through the rod mounting opening and sits within the cap body locking cavity defined by cavity sidewall 306 and thereby locks the decorative cap 290 in place and disallows rotation of the decorative cap 290. In such a locked position, the rod end 236 butts up against the end of rod locking inset 310.

Referring now to FIG. 6, a toilet paper fixture 420 with a mounting assembly 440 including a non-round decorative cap 490 with cap decoration 492 is described. In this case, the decorative cap 490 of a star shape may not need a method of preventing rotation when placed in an assembled position partially within the mounting base 460. However the decorative cap still needs to be pressed and held up against the rim of the mounting base 460 by the toilet paper rod 430 inserted through the mounting base 460 through rod opening defined by rod opening rim 470. In other words, when the decorative cap 490 is not round, it will not rotate relative to the mounting base 460, but will still require locking in position within the mounting base 460. The decorative cap 490 can be any shape, including a star, oval, square, rectangle, triangle or any other shape.

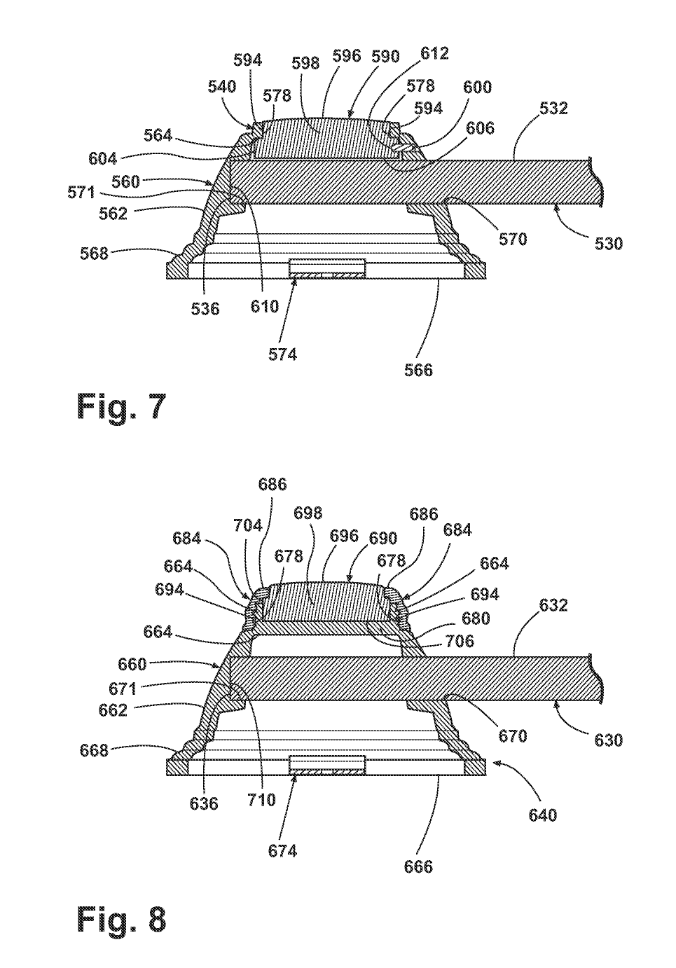

Referring now to FIG. 7, another mechanism for locking the position of the decorative cap 590 onto the mounting base 560 different from the mechanism shown in FIG. 3 is described. As in the case of the mounting assembly 40 of FIG. 3, the mounting assembly 540 the mounting base 560 has a top inset 578 that locks the decorative cap 590 in place on the top rim 564 of the mounting base 560 by engaging a cap body 598 with cap body sidewall 604 of the decorative cap 590. The cap body 598 has a greater diameter than the cap surface 596 with cap surface sidewall 594 and as a result the cap surface 596 and portion of the cap surface sidewall 594 protrudes from within the top rim 564, while the cap body 598 has a diameter too great to protrude from within the top rim 564 of the mounting base 560. In other words, the difference in the diameters between the cap surface 596 and the cap body 598 allows the cap body 598 to engage the top inset 578 of the mounting base 560 and allows the cap surface 596 to protrude through the mounting base top rim 564.

Unlike the mounting assembly 40 of FIG. 3 where the rod 30 engages a rod locking inset 108 in the cap body 98 of the decorative cap 90, with mounting assembly 540 the decorative cap 590 is held in a locked position by a locking screw 600 extending through the mounting base sidewall 562 of the mounting base 560 and engages a locking inset defined by inset sidewall 612 within the cap body 598 of the decorative cap 590. Unlike in the previous embodiments, the bottom of the decorative cap 606 or the body of the cap 598 does not need to contact the rod 530 to lock the orientation of the decorative cap 590. Additionally, in this embodiment, the rod 530 extends substantially the full diameter of the mounting base 560 within the mounting base 560. The rod 530 enters the mounting base 560 through the mounting base rod opening defined by rim 570 and extends to the opposing sidewall section with rod inset defined by inset wall 571 within which the end of the rod 230 rests. In this assembled state, the rod end 536 butts up against the end of rod inset 610.

The locking screw 600 can be the same type as the mounting anchor engagement screw 72. Alternatively, the locking screw 600 can be a different type, shape, and size than the mounting anchor engagement screw. As a further alternative, the locking screw 600 may be replaced with a locking pin that extends through the mounting base sidewall 562 and engages the locking inset defined by locking inset sidewall 612 to lock the position of the decorative cap 590. Yet another alternative to the mounting assembly 540 is with the decorative cap 590 locked in position relative to the mounting base 560 by more than one locking screw 600 inserted into more than one locking inset defined by locking inset sidewall 612. For example there may be two locking screws on two opposing sides of the mounting base 560.

FIG. 8 shows yet another mechanism for locking the position of the decorative cap 690 onto the mounting base 660 different from the locking mechanism shown in FIGS. 3, 5, and 7. As in the case of the mounting assembly 540 of FIG. 7, in the mounting assembly 640 the rod 630 extends substantially the full diameter of the mounting base 660 within the mounting base 560. The rod 630 enters the mounting base 660 through the mounting base rod opening within the sidewall 662 defined by rim 670 and extends to the opposing sidewall 662 section with rod inset defined by inset wall 671 within which the end of the rod 630 rests. In the assembled state, the rod end 636 butts up against the end of rod inset 710.

Continuing with FIG. 8, the mounting and locking of the decorative cap 690 does not involve a cavity or recess bore out in the body 698 of the decorative cap 690 as in the previous embodiments. Instead the decorative cap sits atop a decorative cap platform 680 with the bottom of the decorative cap 706 in contact with the top of the decorative cap platform 680. There is also disposed an annular side wall extension 664 projecting substantially perpendicular to the decorative cap platform 680. The cap body 698 with cap body sidewall 704 sits within the sidewall extension 664 when resting atop the decorative cap platform 680. The side wall extension 664 further has screw threads 694 disposed on its outer edge. A tightening ring 684 comprising inner threads 678 and a tip rim 686 is used to secure the decorative cap 690 in place relative to the mounting base 660. The tightening ring 684 has a re-entrant shape with top rim 686 of the tightening ring 684 having a smaller diameter than the rest of the tightening ring 684. When the tightening ring 684 is screwed on to mounting base 660 and in particular to the sidewall extensions 664 with the tightening ring 684 screw threads 678 engaging the side wall extension 664 screw threads 694, the tightening ring top rim 686 engages the cap body 698 to hold the decorative cap 690 in place on top of the decorative cap platform 680. By tightening the tightening ring 684 to an appropriate level, the rotational orientation of the decorative cap 690 to the mounting base can be maintained.

The mounting assembly 640 of FIG. 8 may have some advantages relative to the mounting assemblies 40, 240, and 540 of FIGS. 3, 5, and 7, respectively, in that changing the decorative cap may be quicker and easier. In the embodiments 40, 240, and 540, to change the decorative caps 90, 290, and 590, the mounting anchor engagement screw must be disengaged, perhaps requiring a screw driver. In the mounting assembly 640, the decorative cap 690 can be changed by loosening the tightening ring 684 with one's fingers. In other words, with this embodiment, the mounting assembly 640 does not have to be dismounted from a wall to change the decorative caps 690.

As an alternative to the threads 678 on the tightening ring 684 and the threads 694 on the sidewall extension 664 and a screwing action therebetween to fasten the tightening ring to the mounting base 660, the tightening ring may be fastened by a compression fit mechanism. In such a mechanism and related apparatus, the threads 678 and 694 may not exist and instead a compressible element such as a gasket may be disposed between the tightening ring 684 and the sidewall extensions 664. The compressible element may be fabricated from any compressible material including, but not limited to elastomers, rubber, or silicone.

Other alternative mechanisms for locking the decorative cap onto the mounting base are within the scope of the invention. One such mechanism is to provide a recess in the mounting base and press the decorative cap into the recess to be frictionally retained therein. Another possible mechanism is to provide internal threads on the recess and eternal threads on the decorative cap, wherein the cap can be threaded into the recess. Another mechanism is to provide a snap fit engagement between the decorative cap and the mounting assembly. In all such mechanism, it is preferable for the decorative cap to be removable.

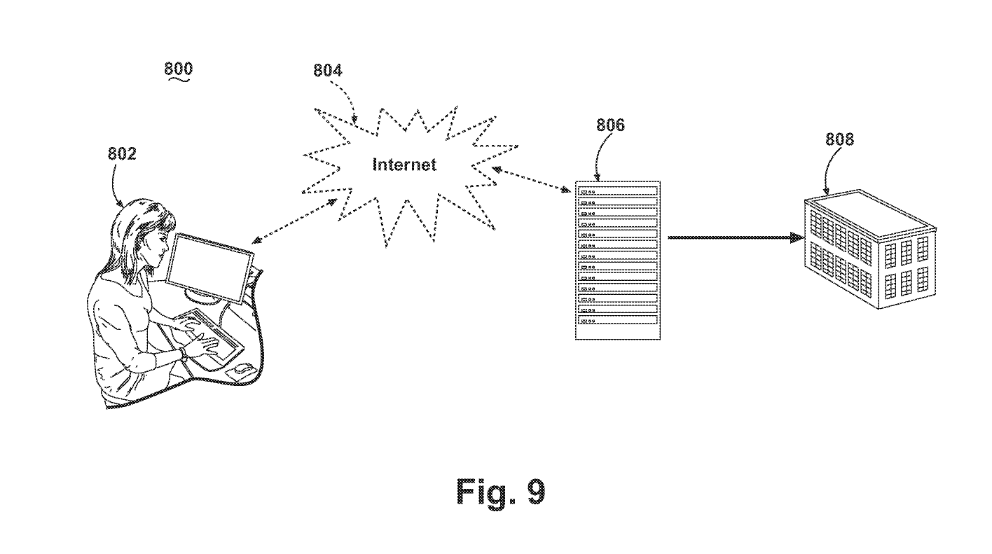

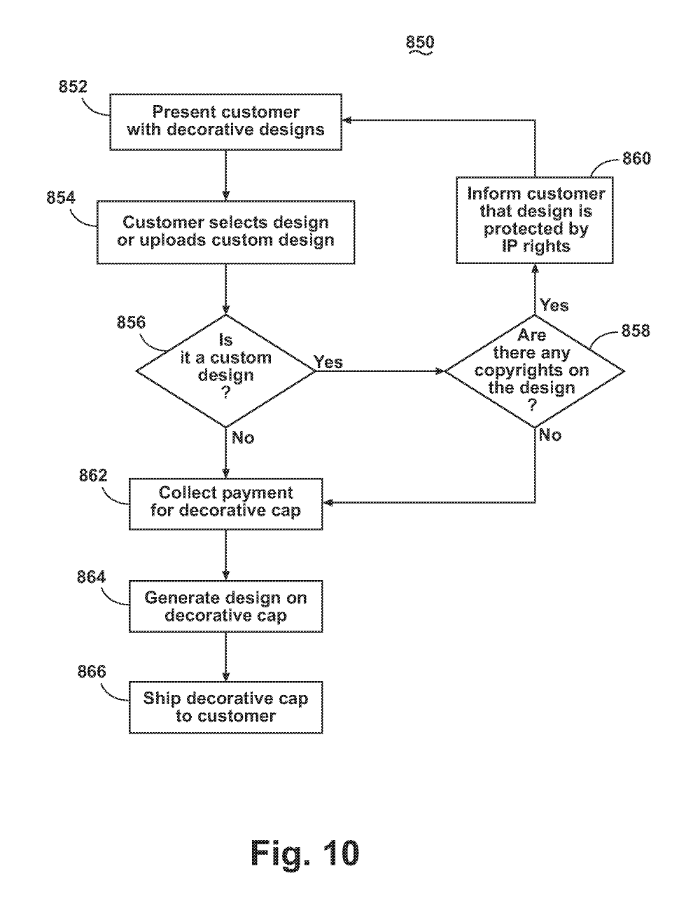

Thus, the decorative caps disclosed herein provide for a highly customizable wall fixture product. It is therefore conceivable that a customer may want to have several decorative caps 90 and periodically order new decorative caps 90. Standard decorative caps 90 may be purchased by the consumer at the store. However, a consumer may want to acquire decorative caps 90 with cap designs provided by the customer. FIGS. 9 and 10 demonstrate a system 800 and method 850 by which decorative caps may be acquired by a customer.

Referring now to FIG. 9, the system 800 for a customer 802 ordering a custom decorative cap 90 is shown. A customer 800 on an electronic device may first access a website of the vendor of the decorative cap over the internet 804. The website can be served by a server 806 of the decorative cap vendor. The server 806 can then route the customer 802 order to a vendor's production facility 808. When the order is completed by the production facility 808 the product can be shipped to the customer 802.

Examples of an electronic device can include any known electronic communication devices, including, but not limited to be any one of a desktop computer, laptop computer, netbook computer, a tablet computing device, a pad computing device, a personal digital assistant (PDA), or a smart phone. The server 806 may be a collection of servers and databases that may or may not be co-located at the vendor site such as at the vender's production facility 808. As an alternative, the server and database 94 may be a virtual server or a cloud server, where the server's functionality and storage is managed remotely by a third party and functionality and storage is allocated to the vendor as needed. The internet connection 804 is illustratively shown as the connection between the customer 802 and the server 806, but any known form of electronic communication network may be used, such as a local area network (LAN). The customer 802 and the vendor's server 806 may use any known method to connect to the internet including, Wi-Fi, Wi-Max, or Ethernet connection. The vendor's production facility 808 may be any facility that can produce the decorative caps and place a cap decoration thereon. Non limiting examples of a vendor's production facilities 808 may include a machine shop, a casting shop, a stamping facility, or a laser etching facility.

The method of ordering a decorative cap 850 using the system 800 of FIG. 9 is described in greater detail in conjunction with FIG. 10. First, the customer is presented with decorative designs at 852. The customer may select one of the designs presented or upload a custom design at 854. It is determined if a custom design is selected at 856. If a custom design is not selected, then the vendor proceeds to collect payment for the decorative cap at 862 and route the order to the production facility 808. The design is generated on the decorative cap at 864 in the production facility 808. Once the decorative cap design is finished, the decorative cap is shipped to the customer at 866. If at 856 it is determined that the design is a custom design then it is next determined if there are any copyrights on the design at 858. If it is determined that there are no copyrights on the custom design uploaded by the customer 802, then the method proceeds to collecting payment for the decorative cap at 862, fabricating the design on the decorative cap at 864, and shipping the decorative cap to the customer at 866. If, however, it is determined that there are copyrights on the custom design uploaded by the customer 802, then the customer is informed that the design is protected by intellectual property rights at 860. The method 850 then loops back to presenting the customer with decorative designs at 852 and allowing the customer 802 to select a predetermined design or upload another custom design at 854.

The predetermined designs presented to the customer 802 at 852 may include both non-copyrighted and copyrighted designs, where the vendor of the decorative caps has agreements to sell designs based on the copyrights with the copyright holders. Presenting the customer with the designs 852 may involve the customer viewing all of the available designs on a web site served by the server 806 on the customer's 802 electronic device. Such a website may further present the ability to search for designs by entering key words.

Determining if a custom design is copyrighted at 858 can involve the website served by the server 806 on the customer's 802 electronic device asking the customer if the design is copyrighted. The customer may for example have to sign a disclaimer acknowledging that the custom design is not copyrighted to proceed to the fabricating of the decorative cap. Determining if a custom design is copyrighted may further involve personnel at the vendor viewing the custom design to determine if the design is copyrighted. Non-limiting examples of copyrighted designs include sports team logos, university logos, television cartoon characters, musical band logos, and the like.

Collecting payment for the decorative cap can encompass any known method of payment collection. Some non-limiting examples include a draw down from a pre-paid debit account with the vendor, a credit card transaction, a debit card transaction, third party payment services, such as PayPal®, an automatic clearing house (ACH) transaction, or a bill later transaction.

The generating the design on the decorative cap at 864 may optionally involve a determination by the vendor of whether the requested design can be correctly and aesthetically transferred to the decorative cap. The transfer of the design onto the surface of the decorative cap can be by a variety of methods including, but not limited to laser engraving, indenting, stamping, casting, ink jet printing, spray painting, or additive three-dimensional solid printing.

The fixture mounting assemblies with interchangeable decorative caps disclosed herein present several advantages over conventional fixtures. For example, the fixtures disclosed here can be easily customizable without customizing every single component of the fixture. In particular, a highly customized product can be offered to the customer by simply providing a choice of decorative caps and without customizing other components of the fixture. As such most of the components of the fixture can be mass produced with a resulting cost benefit and the decorative caps can be customized and sold as higher profit margin parts with a potential of recurring revenue generation once the initial fixture is sold. The user benefits in that the user can change the decorative caps of fixtures throughout the user's home relatively quickly and at a relatively low cost compared to changing all of the fixtures with all of the parts of each fixture in the home. The fixtures disclosed herein provide a quick method of disengaging the mounting assemblies from the surface, such as a wall that they are mounted upon. The fixtures disclosed herein further provide a quick method of interchanging the decorative caps of the fixtures.

A method and system for acquiring custom decorative caps is also disclosed herein. Such a method provides for a customer to quickly and electronically upload a decoration or design to be transferred to the decorative cap and have the custom decorative cap shipped to them. Such a method provides an interface between the customer and the decorative cap fabricators/customizer where the customer does to have to physically go to a store to purchase a decorative cap. Additionally, the customer can have greater choice in decorations than just the inventory held at a store. Furthermore, the method allows for the customer to provide a unique decoration that can be custom transferred to the decorative cap. Additionally, the method checks for copyright protection of designs/decorations provided by the customer.

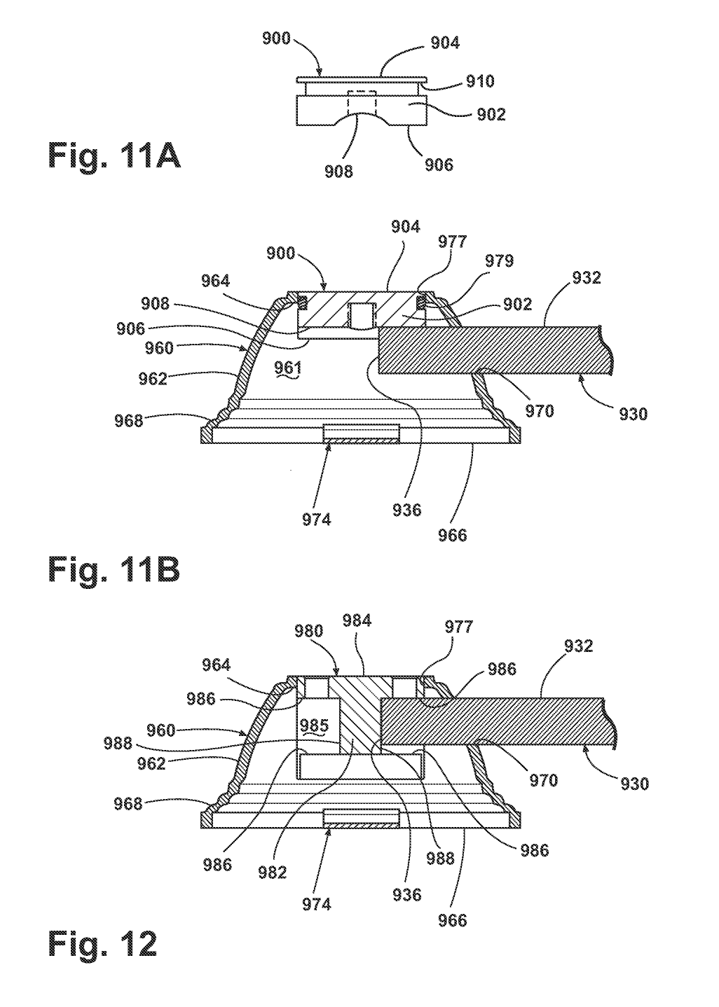

FIG. 11A is a schematic perspective view of a decorative cap 900, which may have a body 902 having a visible surface portion 904 upon which a cap decoration (not shown) may be disposed, according to yet another embodiment of the invention. The embodiment of the decorative cap 900 is similar in some aspects to the embodiments described above and part numbers begin with the 900 series. It may be understood that while like parts may not include like numerals the descriptions of the like parts of the earlier embodiments apply to this embodiment, unless otherwise noted. As with the previously described embodiments the decorative cap 900 may be interchangeable and replaceable. The cap decoration may be applied to the surface portion 904 in any suitable manner including, by way of non-limiting examples, the cap decoration may be etched into the visible surface portion 904 of the decorative cap 900 or the decoration may be painted onto the visible surface portion 904 of the decorative cap 900. The body 902 may include a rear portion 906 having an elongated recess 908 extending at least partially therethrough. In the illustrated embodiment the elongated recess 908 extends entirely through the body 902 although this need not be the case. A channel 910 may also be formed within the body 902 and may circumscribe an upper portion of the body 902 below the visible surface portion 904. The channel 910 may be adapted for seating a suitably sized seal such as an O-ring therein.

FIG. 11B illustrates a cross-sectional view of a mounting base 960 and rod 930 according to yet another embodiment of the invention. The mounting base 960 and rod 930 are not unlike to the first embodiment; therefore, like parts will be identified with like numerals increased by 900, with it being understood that the description of the like parts of the first embodiment applies to this embodiment, unless otherwise noted. As with the first embodiment the mounting base 960 may include an inner cavity 961 defined by a sidewall 962 and a top opening defined by a top rim 964, and adapted to mount to a surface with a mounting bracket or mounting anchor 974. The top rim 964 may include a shoulder 977, which may be configured to engage the decorative cap 900. The elongated rod 930 may be mounted to the mounting base 960 within the inner cavity 961 through the mounting opening rim 970 of the mounting base 960. The elongated rod 930 may be one of a towel bar, a handle, and a shelf support. The elongated rod 930 need not extend through the mounting opening rim 970. It is within the scope of the invention for the elongated rod to be contained entirely within the inner cavity 961, mounted, for example, between the opposite sides of the sidewall 962. In such case, there may not be mounting opening rim 970.

A difference between this embodiment and the first embodiment is that the decorative cap 900 may be inserted through the opening formed by the shoulder 977 of the top rim 964 such that the rear portion 906 is disposed within the inner cavity 961 and the visible surface portion 904 extends into the top opening of the mounting base 960 where it may be frictionally retained therein by the shoulder 977. The decorative cap 900 may be held between the elongated rod 930 and the shoulder 977. A seal 979 is shown as being located in the channel 910 and may aid in the frictional retention of the decorative cap 900 within the mounting base 960.

The elongated recess 908 may be configured to nest with the elongated rod 930. It is contemplated that the rear portion 906 and the elongated recess 908 may have a predefined orientation relative to the visible surface portion 904 such that when the elongated recess 908 nests with the elongated rod 930, the visible surface portion 904 will be automatically oriented relative to the mounting base 960. It is also contemplated that the elongated recess 908 may have a radius of curvature substantially similar to the radius of curvature of the elongated rod 930. In this manner, both the decorative cap 900 and the elongated rod 930 may be held in place such that they will not rattle and will not spin. Further, the elongated portion 908 may prevent the misalignment of the elongated rod 930 when the elongated rod 930 is inserted within the rod mounting opening rim 970.

FIG. 12 is a cross-sectional view of the mounting base 960, the elongated rod 930 and a decorative cap 980 according to yet another embodiment of the invention. The decorative cap 980 is similar in some aspects to the embodiment described above and part numbers continue in the 900 series. It may be understood that while like parts may not include like numerals the descriptions of the like parts of the earlier embodiments apply to this embodiment, unless otherwise noted. As with the above embodiment, the decorative cap 980 may be inserted through the opening formed by the inner edge 977 of the top rim 964 such that its rear portion is disposed within the inner cavity 961 and the visible surface portion 984 extends into the top opening of the mounting base 960 and the decorative cap 980 may be held by friction with the top rim 964.

One difference is that no seal or channel is included in this embodiment. Further, instead of the elongated portion several cavities 985 are formed by cavity sidewalls 986 in the body 982 of the decorative cap 980 such that when the elongated rod 930 is inserted through the rod mounting opening rim 970 it may sit within the cavity 985 defined by cavity sidewalls 986 and the rod end 936 may butt up against the end of cavity 988. This locks the decorative cap 980 in place and disallows rotation of the decorative cap 290. In such position, neither the decorative cap 980 nor the elongated rod 930 may rattle or spin during use. Further, the cavity 985 prevents the misalignment of the rod 930 when the rod is inserted within the rod mounting opening rim 970. Although the body 982 is illustrated as having multiple cavities 985 it is contemplated that only one cavity may be included in the body 982. The cavity 988 may have a predefined orientation relative to the visible surface portion 984 such that when the cavity 988 nests with the elongated rod 930, the visible surface portion 984 will be oriented relative to the mounting base 960.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

What is claimed is:

1. A fixture for mounting to a surface comprising:
a mounting base with an inner cavity defined by a sidewall and a top opening defined by a top rim, and adapted to mount to the surface with a mounting bracket;
an elongated rod mounted to the mounting base within the inner cavity; and
a decorative cap having a rear portion disposed within the inner cavity and a visible portion extending into the top opening of the mounting base,
wherein the rear portion has an elongated recess configured to nest with the elongated rod and the rear portion further has a predefined orientation relative to the visible portion so that when the elongated recess nests with the elongated rod, the visible portion will be automatically oriented relative to the mounting base.

2. The fixture of claim 1 wherein the decorative cap is held by friction with the top rim.

3. The fixture of claim 1 wherein the elongated rod extends outwardly of the inner cavity through a rod opening in the sidewall of the mounting base.

4. The fixture of claim 3 wherein the rod is one of a towel bar, a handle, and shelf support.

5. The fixture of claim 1 wherein the top rim has a shoulder and the decorative cap is held between the elongated rod and the shoulder.

6. The fixture of claim 5 wherein a surface portion of the decorative cap has a cap decoration on the visible portion.

7. The fixture of claim 6 wherein the cap decoration is etched into the surface portion of the decorative cap.

8. The fixture of claim 6 wherein the cap decoration is painted onto the surface portion of the decorative cap.

9. The fixture of claim 1 wherein the recess has a radius of curvature substantially similar to the radius of curvature of the elongated rod.

10. A method of acquiring a decorative cap by a customer from a vendor comprising the steps of:
presenting the customer with choices of designs for decorative caps on a customer's electronic device;
the customer selecting one of the designs presented on the electronic device or a custom design via the electronic device connected to a network; and
the electronic device communicating the selection via the network to a vendor's server;
the vendor's server collecting payment for generating the customer's selected design; and generating the selected design on decorative cap.

11. The method of claim 10, further comprising the step of verifying if a custom design has copyright protection.

12. The method of claim 11 wherein a custom design with copyright protection is not generated on the decorative cap.
